(19) United States
(12) Patent Application Publication
(10) Pub. No.: US 2006/0036802 A1
(43) Pub. Date: Feb. 16, 2006

(54) Flash file system management

(75) Inventor: Vladimir Drukin, Raanana (IL)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/916,990

(22) Filed: Aug. 11, 2004

(51) Int. Cl. G06F 12/00

(52) U.S. Cl. 711/103; 711/159

(57) ABSTRACT

A method for managing a flash file system is provided. The method comprises receiving new data to replace old data stored in a first block in flash memory, wherein the first block is represented by a first node linked to a preceding node and a successive node; instantiating a second node representing a second block in flash memory; storing new data in the second block; and linking the preceding node and the successive node to the second node.

### BACKGROUND

1. Field of Invention

The present invention relates generally to managing a flash file system (FFS) and, more particularly, to enhancing the performance of a flash file system.

2. Copyright & Trademark Notices

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

3. Related Art

Flash memory is a common storage medium in embedded devices, because it provides solid-state storage with high reliability and high density, at a relatively low cost. Flash is a form of Electrically Erasable Read Only Memory (EEPROM), available in two major types. The traditional NOR flash is a directly accessible storage device. It allows fast data access, but is expensive. The slower and less expensive NAND flash is addressable through a single 8-bit bus used for both data and addresses with separate control lines.

Generally, flash chips are arranged into blocks, which are 128 KiB for NOR flash chips and 8 KiB for NAND flash chips. In prior art flash file systems, each bit in a clean flash chip is set to a logical one. Selected clean bits can be set to zero by a write operation to store data in the flash.

The lifetime of a flash chip is measured in erase cycles, with the typical lifetime being 100,000 erases per block. To ensure that no one block reaches this limit before the rest of the blocks, the erase cycles need to be evenly distributed. This distribution process is known as wear leveling.

In order to erase content stored in a bit of flash memory, the particular bit will have to be reset to one. Bits in NAND flash chips cannot be individually reset since bits in a NAND flash chip are not directly accessible. That is, the bits are divided into “pages” (typically 512 bytes in size). A NAND flash is written by loading the data into an internal buffer, one byte at a time. A write command is then issued to reset a bit from zero to one. The updated bits in the buffer are then written as a block to the flash chip.

In a NAND flash chip, a complete block needs to be reset by way of a write operation in order to change individual bits in a page. As stated earlier, due to its physical attributes, a NAND flash can accommodate a limited number of such write cycles before leakage causes the contents to become undefined.

Flash file storage applications use a file structure that emulates a block device with standard 512-byte sectors based on a one-to-one mapping from the emulated block device to the flash chip. To simulate the smaller sector size for write requests, the whole erased block is read by the system first into a buffer. Once the appropriate parts of the buffer are modified, the entire block is erased and rewritten. Unfortunately, data loss can result in case of a power interruption between the erase and a subsequent rewrite cycle.

To avoid this, typically, a translation layer is used to keep track of the current location of each sector in the emulated block device. The translation layer is a form of journaling that allows for data rollback in case of an accidental power interruption, by keeping a copy of the old version of the data, until the updated data is written to the flash.

Unfortunately, the journaling procedure for emulating a block device is inefficient because it requires saving original unaltered content of every page of data into a journal file, in case of a need for data rollback. Once the data in each page is updated, then the journal file is deleted.

The above-noted approach involves lengthy delays associated with the overhead requirements for a rollback operation. A more efficient use of flash technology is desirable that accommodates a rollback operation without the need for extra layers of journaling.

### SUMMARY

The present disclosure is directed to a system and corresponding methods for managing a flash file system implemented to store data in an embedded computing environment.

For the purpose of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested.

In accordance with one or more embodiments, a method for managing a flash file system is provided. The method comprises receiving new data to replace old data stored in a first block in flash memory, wherein the first block is represented by a first node linked to a preceding node and a successive node; instantiating a second node representing a second block in flash memory; storing new data in the second block; and linking the preceding node and the successive node to the second node.

The method may further comprises unlinking the first node from the preceding and successive nodes, wherein the unlinking the first node from the preceding and successive nodes is performed, after the new data is committed to a database in the flash memory. The first node is then deleted and the first block is unallocated from the flash memory, after the new data is committed to the database in flash memory.

In one embodiment, the preceding node unlinked and the successive node are unlinked from the second node, in response to a first condition. The first condition may comprise a power loss or a request to roll back the database to the old data. In one embodiment, the second node is deleted after the unlinking procedure and the second block is unallocated from the flash memory.

In accordance with another embodiment, a method for managing a flash file system is provided. The method comprises receiving new data to replace old data stored in a first block in flash memory, wherein the first block is represented by a first node linked to a preceding node and a successive node by way of first and second pointers, respectively; instantiating a second node representing a second block in flash memory; storing new data in the second block; and linking the preceding node and the successive node to the second node by way of third and fourth pointers, respectively.

The first and second pointers linking the first node and the preceding and successive nodes are deactivated by way of setting an index field to a first value, wherein the index field is included in a node associated with the first node. Further, the third and fourth pointers linking the second node and the preceding and successive nodes are deactivated by way of setting an index field to a first value, wherein the index field is included in a node associated with the first node.

The node associated with the first node maybe a root node for a linked list comprising the first node and the preceding and successive nodes, for example. Or, the node associated with the second node may be a root node for a linked list comprising the second node and the preceding and successive nodes, for example. The linked list comprises at least one node, wherein the at least one node comprises a root indicator field that can be set to indicate that the node is a root node.

In accordance with yet another embodiment, a linked list structure for updating data in a database implemented in flash memory is provided. The linked list structure comprises a plurality of nodes, each node comprising a first pointer field, a second pointer field, a root indicator field, and a current index field, wherein the first pointer field is active when the current index field is set to a first value, and wherein the second pointer field is active when the current index field is set to a second value, such that when a record in the database is updated, a first node representing a first block comprising old data is replaced with a second node representing a second block comprising new data, by way of deactivating the first pointer fields for preceding and succeeding nodes of the first node that respectively link the first node to the preceding and succeeding nodes, and activating the second pointer fields for the preceding and succeeding nodes of the first node to respectively link the second node to the preceding and succeeding nodes.

The root indicator field is set to indicate that a node from among said plurality of nodes is a root node. The updated record in the database is reverted to comprise the old data, if the new data is not committed, by way of deactivating the second pointer fields for the preceding and succeeding nodes of the first node to respectively unlink the second node from the preceding and succeeding nodes, and activating the first pointer fields for preceding and succeeding nodes of the first node to respectively link the first node to the preceding and succeeding nodes. In one embodiment, the first node is deleted after the new data is committed to the database.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary file system structure prior to changes made to data stored in the file system, in accordance with one embodiment of the invention;

FIG. 2 illustrates the exemplary system structure of FIG. 1, after changes are made to data stored in the file system, in accordance with one embodiment of the invention;

FIG. 3 illustrates an exemplary system structure of FIG. 2, after changes made to data stored in the file system are committed, in accordance with one embodiment of the invention; and

FIGS. 4A and 4B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

A computing system and corresponding computer executable methods, according to an embodiment of the present invention, facilitate and provide means for managing a flash file system in an embedded computing environment. The embedded computing environment may comprise embedded devices, systems, or software with system architectures dedicated to performing special functions, instead of providing a general-purpose computing environment.

In one embodiment, embedded software is installed and executed on an embedded system, such as a mobile communication device, a personal digital assistance (PDA), or other dedicated device. The embedded software or content may be database software configured for managing a flash file system and is permanently installed on read-only memory, such as a ROM or flash memory chip, for example.

It is noteworthy that while one or more embodiments of the invention are described as applicable to embedded systems and environments, some embodiments of the invention may be practiced as applicable to general-purpose computing systems. Thus, the scope of the invention should not be construed as limited to embedded systems having flash memory. For example, in one embodiment, system or database software may be stored in other types of storage media (e.g., read access memory (RAM), magnetic media, optical media, etc.) for the purpose of execution.

Numerous specific details are set forth to provide a thorough description of various embodiments of the invention. Certain embodiments of the invention may be practiced without these specific details or with some variations in detail. In some instances, certain features of the system may be described in less detail so as not to obscure other aspects of the invention.

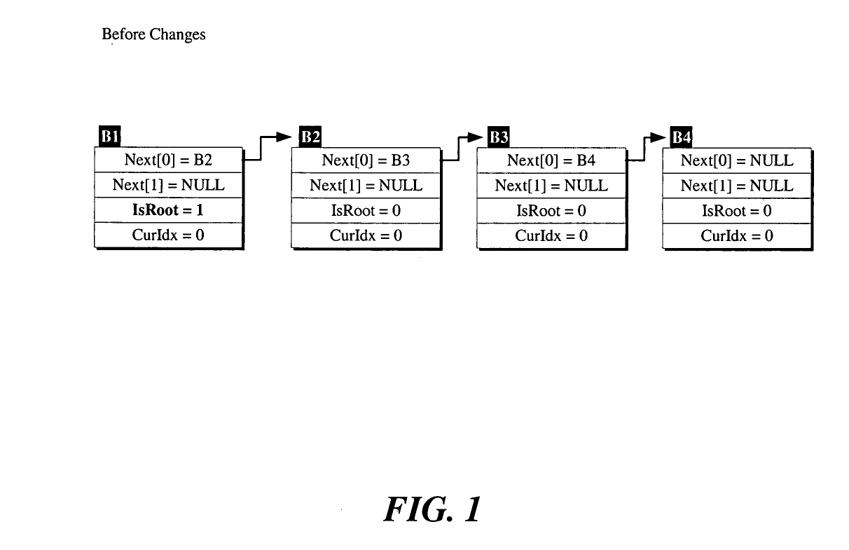

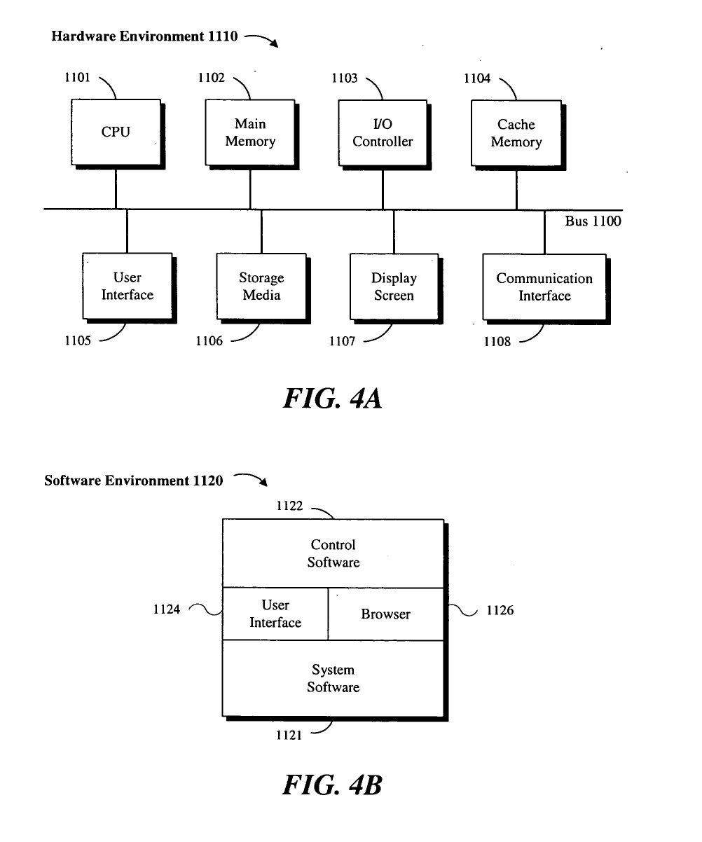

Referring to FIGS. 1, 4A and 4B, in one or more embodiments of the present invention, control software 1122 runs in an embedded environment comprising a microcontroller for executing control software 1122 and a flash memory for storing a database structure as shown in FIG. 1. It is noteworthy that the data structures illustrated and discussed here are provided by way of example and should not be construed to limit the scope of the invention to the particular embodiments.

For example, the database structure illustrated in FIGS. 1-3 may be implemented as a linked list. In other embodiments, different forms and types of data structures (e.g., arrays, tables, etc.) may be utilized instead of a linked list structure. The linked list, as shown, comprises a plurality of nodes with a root node at the beginning of the linked list and a tail node at the end. Each node may logically point (i.e., link) to one or more nodes to allow for the organization of a sequential set of data stored in, for example, noncontiguous storage locations in flash memory.

In accordance with one aspect of the invention, nodes B1 through B4 represent a set of logical blocks in flash memory. Each block is suitable for storage of a plurality of bits (e.g., 4 KiB or 8 KiB). Assuming an 8-KiB block size, 32 KiB of data may be stored in blocks represented by nodes B1 to B4, for example. Depending on implementation, each node comprises one or more fields wherein data and control information are stored.

In one embodiment, each node comprises fields Next[0] and Next[0], for example. Fields Next[0] and Next[1] act as pointers in that they comprise a logical address for a subsequent node, such that the nodes can be linked in a particular order. Advantageously, the order of the nodes can be easily modified by changing the pointers (i.e., links). The linked list approach allows for data stored in non-contiguous blocks of the memory to be reordered as if they were stored contiguously, by simply linking the representative nodes for each block in succession.

As such, referring to FIG. 1, successive sets of information may be stored in nodes B1, B2, B3 and B4, respectively, regardless of the physical B1.Next[0] represents a pointer that points to node B2; the field B2.Next[0] represents a pointer that points to node B3; and so on. The last node (e.g., node B4) points to a NULL node (i.e., B4.Next[0]=NULL). Accordingly, B1 is the root node and B4 is the tail node for the exemplary linked list structure illustrated in FIG. 1.

In one embodiment, each node may also comprise a plurality of additional fields comprising a root indicator field or flag (e.g., IsRoot) and a current index indicator value (e.g., CurIdx), for example. The root indicator field can be assigned a value (e.g., 0 or 1) to indicate whether or not the respective node is a root node. A first value (e.g., 1) will indicate a root node, and a second value (e.g., 0) will indicate otherwise. For example, in the data structure illustrated in FIG. 1, node B1 is the root node because the root indicator value is equal to 1 (i.e., IsRoot=1).

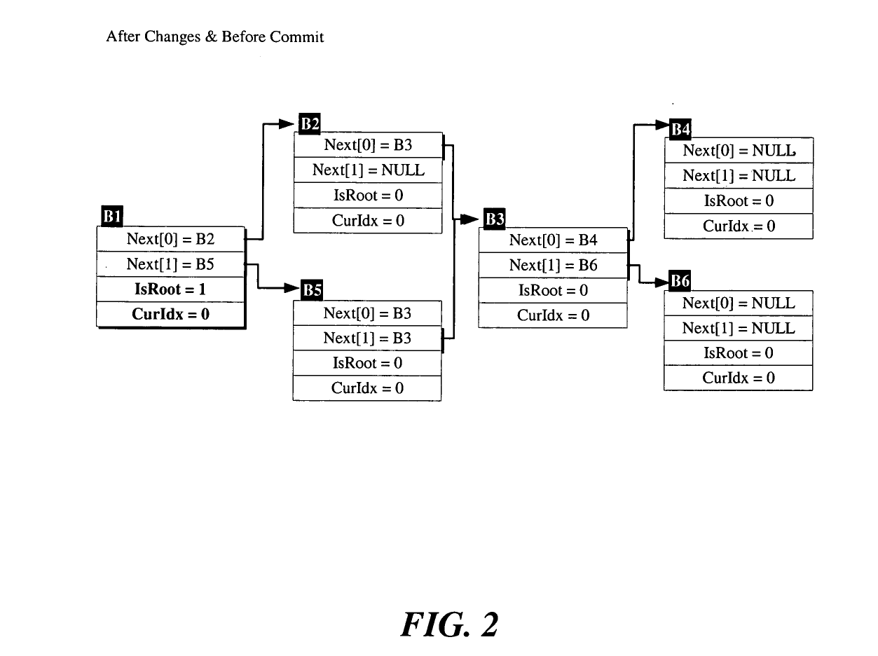

Referring to FIG. 2, if content of a database record stored in a first block in the flash chip (e.g., represented by node B2) is to be changed, edited, updated, or replaced, then control software 1122 instantiates or creates a new node (e.g., node B5) and the updated content for the database record is stored in a second data block represented by the new node. In accordance with one aspect of the invention, the original content of the first block is not deleted, however, until after the changes are committed to the database.

The term committed refers to the process in which the changes are permanently stored in the database. For example, FIG. 2 illustrates an instance where the changes are made to a record with data stored in a first block (e.g., represented by node B2), but changes are not yet committed. In such an instance, a predecessor node (e.g., node B1) that points to a first node (e.g., node B2), representing the first block, is configured to have pointers Next[0] and Next[1], for example. Pointer Next[0] points to the first node (e.g., node B2) and Next[1] points to a second node (e.g., new node B5), respectively.

The first node (e.g., node B2) comprises the original content stored in the first block. The second node (e.g., node B5) comprises the updated content that will replace the original content after the changes are committed. The second node (e.g., node B5) is newly instantiated and represents a second block on flash memory that is available to store the updated content.

Unlike related art file systems, in accordance with one aspect of the invention, the second block is not a temporary memory space for storing the updated data, until the content of the first data is deleted. That is, the second block (e.g., represented by node B5) replaces the first block (e.g., represented by node B2) when the precedent node's (e.g., node B1) current pointer value (e.g., CurIdx) is set to a first value (e.g., CurIdx=1) to cause the precedent node (e.g., node B1) to point to the second node (e.g. B5).

To complete the above block replacement, a second node (e.g., node B5) is configured to have at least one of its pointers (e.g., B5.Next[1]) to point to a successor block (e.g., represented by node B3) of the first block (e.g., represented by node B2), in accordance to one embodiment. It is noteworthy that depending on implementation one or more fields (e.g., B5.Next[0]) may be set to point to the successor block.

For clarity, we refer to the relationship between exemplary nodes B1, B2 and B5 illustrated in FIGS. 1 through 3, wherein node B2 is replaced with node B5. Referring to FIG. 2, in the instance prior to the time when changes are committed to the database, values assigned to the first and second pointers (e.g., fields Next[0] and Next[1]) for each node can be demonstrated as provided below.
B1.Next[0]=B2
B1.Next[1]=B5
B2.Next[0]=B3
B2.Next[1]=NULL
B5.Next[0]=B3
B5.Next[0]=B3

The value of the root field (e.g., IsRoot) and current index (e.g. CrIdx) for each node preferably remains unchanged, in one or more embodiments, until after the changes are committed to the database. In other embodiments and depending on implementation, the values of the respective fields may be updated, prior to the time the changes are committed.

In one embodiment of the invention, if the changes to the database are not committed, the changes may be reversed so that the database can be restored to its original state. For example, in case of a power loss, or under other circumstances in which data rollback is necessary (e.g., a user decides not to commit the changes made to data) there is a need for restoring the database to its previous state.

If the changes are not committed, then the database can be restored to its previous state by configuring the second field (e.g., Next[1]) of the root node or the nodes preceding the updated nodes to be equal to NULL, for example. The relationship between exemplary nodes B1, B2 and B5 after the database is restored to a previous state can be demonstrated based on the values assigned to the first and second pointers (e.g., fields Next[0] and Next[1]) for each node as provided below.
B1.Next[0]=B2
B1.Next[1]=NULL
B2.Next[0]=B3
B2.Next[1]=NULL
B5.Next[0]=any value
B5.Next[1]=B3

In certain embodiments, setting the first pointer (e.g., Next[0]) to NULL may not be needed, so long as the current index value is set to activate the second pointer (e.g., Next[1]) and to deactivate the first pointer (e.g., Next[0]). In one embodiment, the newly instantiated node (e.g., B5) representing the new block where the updated data is stored is deleted either by way of a delete instruction issued by control software 1122 or during a garbage collection process, for example, to complete the rollback procedure.

Garbage collection process is a software routine that searches the flash memory for allocated areas in memory with inactive data (i.e., garbage or dirty blocks) in order to reclaim the allocated space as useful memory space. Thus, once the garbage collection procedure is completed, the memory space allocated to node B5 and the corresponding block in memory are freed.

Accordingly, if data rollback needs to be performed, the original data can be restored to the database by simply removing a pointer (e.g., B1.Next[1]) to the newly allocated node (e.g., B5) and setting it to a NULL value. Thus, in one embodiment, the related art requirement and overhead associated with making a duplicate copy of the original data and storing it in a separate buffer or flash block as a backup is eliminated.

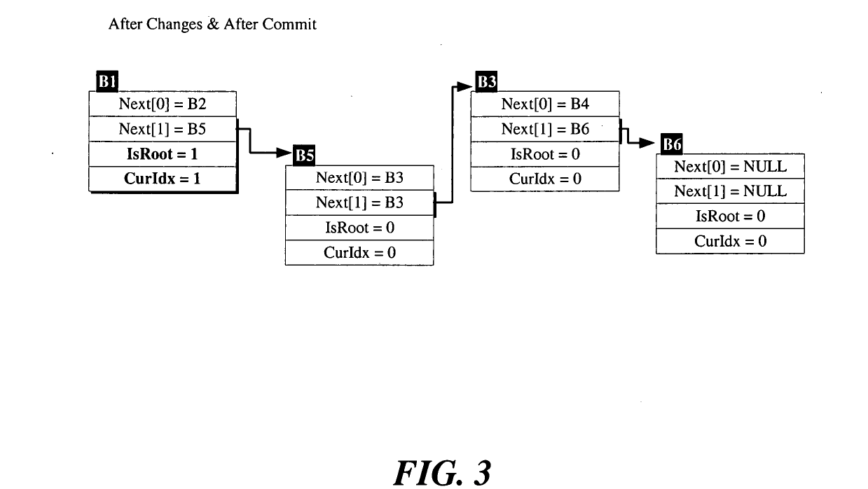

Referring to FIG. 3, after content of the database are changed and committed, the updated information is permanently stored in the database. This is accomplished by removing the first pointer (e.g., B1.Next[0]) pointing to the first block (e.g., represented by node B2) and setting the current index (e.g., CurIndx) to indicate that a second pointer (e.g., B1.Next[1]) provides the link to the new node (e.g., node B5). Node B2 and the corresponding block in memory can be then freed by way of a delete instruction or a garbage collection process.

The relationship between exemplary nodes B1, B2 and B5 after the changes to the database are committed can be demonstrated based on the values assigned to the first and second pointers (e.g., fields Next[0] and Next[1]) and current index (e.g., CurIdx) for each node as provided below.
B1.Next[0]=any value
B1.Next[1]=B5
B1.CurIdx=1
B2: Deleted
B5.Next[0]=any value
B5.Next[1]=B3

Referring to FIGS. 1 through 3, node B4 is illustrated as an exemplary node representing a block that is updated in accordance with one embodiment of the invention. In this description, however, for the purpose of brevity the changes made to fields of node B4 or its preceding or successive nodes are not discussed. It is noteworthy, however, that a similar method as provided with respect to node B2 may be employed to update the content of the respective block represented by node B4.

In one embodiment, the value of the current index in a node is set to a first value (e.g., 0) to indicate that a first pointer (e.g., Next[0]) provides a link to the next node, and to a second value (e.g., 1) to indicate that a second pointer (e.g., Next[1]) provides a link to the next node. Thus, for example, when current index is set to one (CurIdx=1) for the root node B1, then the successive node for node B1 becomes B5, the node pointed to by B1.Next[1]. At this point, the value of B1.Next[0] is no longer important and can be set to NULL, in accordance with one embodiment, for example.

In one embodiment, the root node's current index value is set to the second value (e.g., 1) to indicate that the second pointer (e.g., Next[1]) for all other nodes will provide the link to the next node for each respective node. As such, the current index value for the remainder of the nodes is not set to the second value (e.g., 1), in one embodiment.

Referring to FIG. 3, once current index value for the root node B1 is set to a first value (e.g., B1.CurIdx=1) then the next node pointer for all other nodes is switched to Next[1]. That is, for example, referring to node B3, the next node pointer is automatically changed to point to node B6, the node pointed to by B3.Next[1], without the need for current index value for node B3 (e.g., B3.CurIdx) to be set to a first value (e.g., 1).

In other embodiments and depending on implementation, the current index value for all other nodes maybe set to a second value, when the current index value for the root node is set to a second value. Accordingly, in one embodiment of the invention, the current index value for a non-root node is changed when the current index for the root node is set, and in another embodiment, the current index value for a non-root node remains unchanged even if the current index value for the root node is set.

According to the above teachings, in one or more embodiments, an embedded database in flash memory can be updated, restored, and managed based on the above linked list file system implementation and without the need for a separate file system (e.g., FAT16) to operate on top of the flash file system.

In some embodiments, the updating, restoring and managing functions discussed above are implemented in hardware, or a combination of hardware and software. As such, although control software 1122 is disclosed as applicable to the system of the present invention, this application is by way of example and shall not be construed to limit the scope of the invention to a software solution.

In some embodiments of the system, the computing environment disclosed above comprises a controlled system environment that can be presented largely in terms of hardware components and software code executed to perform processes that achieve the results contemplated by the system of the present invention. A more detailed description of an exemplary system environment is provided below with reference to FIGS. 4A and 4B.

As shown, a computing system environment is composed of two environments, a hardware environment 1110 and a software environment 1120. The hardware environment 1110 comprises the circuitry and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and control software 1122. System software 1121 comprises control programs, such as the operating system (OS) and information management systems that instruct the hardware how to function and process information. Control software 1122 is a program that performs a specific task, such as managing a file system and database updates. In certain embodiments of the invention, system and application software are implemented and executed on one or more hardware environments, for example.

Referring to FIG. 4A, an embodiment of the control software 1122 can be implemented as logic code in the form of computer readable code executed on a general purpose hardware environment 1110 that among other components comprises the circuitry for implementing a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a wireless network card, a Blue tooth port, a wireless modem, etc.), and a system synchronizer (e.g., a clock, not shown in FIG. 4A).

Cache memory 1104 is utilized for storing frequently accessed information. A communication mechanism, such as a bi-directional data bus 1100, can be utilized to provide for means of communication between system components. Hardware Environment 1110 is capable of communicating with local or remote systems connected to a wireless communications network (e.g., a PAN or a WAN) through communication interface 1108.

In one or more embodiments, hardware environment 1110 may not include all the above circuitry, or may include one or more circuits for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless communication device (e.g., cellular phone), or other similar hardware platforms that have information processing and/or data storage and communication capabilities. For example, in one or more embodiments of the system, hardware environment 1110 may comprise a PMG unit or an equivalent thereof.

In some embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems corporations, for example. The named processors are for the purpose of example only. Any other suitable microprocessor, microcontroller, or microcomputer may be utilized.

Referring to FIG. 4B, software 1120 or one or more of its components is stored in storage media 1106 and is loaded into memory 1102 prior to execution. Software environment 1120 comprises system software 1121 and control software 1122. Depending on system implementation, certain aspects of software environment 1120, and particularly control software 1122, can be loaded on one or more hardware environments 1110, or subcomponents thereof.

System software 1121 comprises software such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows, Microsoft Windows, Macintosh OS, or IBM OS/2. However, any other suitable operating system may be utilized.

Control software 1122 can comprise one or more computer programs that are executed on top of system software 1121 after being loaded from storage media 1106 into memory 1102. In a client-server architecture, control software 1122 may comprise client software and/or server software. Referring to FIG. 1, for example, in one embodiment of the invention, client software is executed on mobile devices 200 and server software is executed on device 300.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods for managing a file system. In this exemplary embodiment, logic code for performing these methods is implemented in the form of, for example, control software 1122. The logic code, in one embodiment, may be comprised of one or more modules that execute on one or more processors in a distributed or non-distributed communication model. For example, one or more embodiments of the present invention may comprise separate radio and baseband modules, or alternatively modules incorporating the radio, baseband, micro-controller and flash memory in a single-chip solution.

It should also be understood that the circuitry, programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a single computer, circuitry, or a plurality of computers or circuitry. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. A method for managing a flash file system, the method comprising:
receiving new data to replace old data stored in a first block in flash memory, wherein the first block is represented by a first node linked to a preceding node and a successive node;
instantiating a second node representing a second block in flash memory;
storing new data in the second block; and
linking the preceding node and the successive node to the second node.

2. The method of claim 1, further comprising:
unlinking the first node from the preceding and successive nodes.

3. The method of claim 2, wherein the unlinking the first node from the preceding and successive nodes is performed, after the new data is committed to a database in the flash memory.

4. The method of claim 3, further comprising deleting the first node.

5. The method of claim 3, wherein the first block is unallocated from the flash memory, after the new data is committed to the database in flash memory.

6. The method of claim 1, further comprising:
unlinking the preceding node and the successive node from the second node, in response to a first condition.

7. The method of claim 6, wherein the first condition comprises a power loss.

8. The method of claim 6, wherein the first condition comprises receiving a request to roll back to the old data.

9. The method of claim 6, further comprising deleting the second node.

10. The method of claim 6, wherein the second block is unallocated from the flash memory.

11. A method for managing a flash file system, the method comprising:
receiving new data to replace old data stored in a first block in flash memory, wherein the first block is represented by a first node linked to a preceding node and a successive node by way of first and second pointers, respectively;
instantiating a second node representing a second block in flash memory;
storing new data in the second block; and
linking the preceding node and the successive node to the second node by way of third and fourth pointers, respectively.

12. The method of claim 11, further comprising:
deactivating the first and second pointers linking the first node and the preceding and successive nodes, by way of setting an index field to a first value, wherein the index field is included in a node associated with the first node.

13. The method of claim 11, further comprising:
activating the third and fourth pointers linking the second node and the preceding and successive nodes, by way of setting an index field to a first value, wherein the index field is included in a node associated with the first node.

14. The method of claim 12, wherein the node associated with the first node is a root node for a linked list comprising the first node and the preceding and successive nodes.

15. The method of claim 13, wherein the node associated with the second node is a root node for a linked list comprising the second node and the preceding and successive nodes.

16. The method of claim 14, wherein the linked list comprises at least one node, wherein the at least one node comprises a root indicator field that can be set to indicate that the node is a root node.

17. A linked list structure for updating data in a database implemented in flash memory, the linked list structure comprising:
a plurality of nodes, each node comprising a first pointer field, a second pointer field, a root indicator field, and a current index field,
wherein the first pointer field is active when the current index field is set to a first value, and
wherein the second pointer field is active when the current index field is set to a second value,
such that when a record in the database is updated, a first node representing a first block comprising old data is replaced with a second node representing a second block comprising new data, by way of
deactivating the first pointer fields for preceding and succeeding nodes of the first node that respectively link the first node to the preceding and succeeding nodes, and
activating the second pointer fields for the preceding and succeeding nodes of the first node to respectively link the second node to the preceding and succeeding nodes.

18. The linked list structure of claim 17, wherein the root indicator field is set to indicate that a node from among said plurality of nodes is a root node.

19. The linked list structure of claim 17, wherein the updated record in the database is reverted to comprise the old data, if the new data is not committed, by way of:
deactivating the second pointer fields for the preceding and succeeding nodes of the first node to respectively unlink the second node from the preceding and succeeding nodes, and
activating the first pointer fields for preceding and succeeding nodes of the first node to respectively link the first node to the preceding and succeeding nodes.

20. The linked list structure of claim 17, wherein the first node is deleted after the new data is committed to the database.
